(19) United States
(12) Patent Application Publication
(10) Pub. No.: US 2014/0346157 A1
(43) Pub. Date: Nov. 27, 2014

(54) METHOD TO CONTROL THE ENVIRONMENT IN A LASER PATH

(71) Applicant: SLD Enhanced Recovery, Inc., Houston, TX (US)

(72) Inventors: Tamas Bozso, Kecskemet (HU); Robert Bozso, Helvecia (HU)

(21) Appl. No.: 14/374,805

(22) PCT Filed: Jan. 28, 2013
(86) PCT No.: PCT/US2013/023455

§ 371 Date: Jul. 25, 2014

(30) Foreign Application Priority Data
Jan. 26, 2012 (HU) P1200062

(51) Int. Cl. B23K 26/00; E21B 37/00; E21B 21/16; E21B 7/15; E21B 29/02

(52) U.S. Cl. CPC B23K 26/0066; E21B 7/15; E21B 29/02; E21B 21/16; E21B 37/00
USPC 219/121.85; 166/250.01; 175/16

(57) ABSTRACT

A method of controlling the environment intermediate a laser head and a targeted portion of a bore wall to remove solid material at the wall includes running an umbilical into the bore to position the head, irradiating the targeted portion of the wall using laser light, sensing a light spectrum resulting from irradiation of the solid material, comparing the sensed light spectrum to a light spectrum corresponding to favorable irradiation of the solid material, adjusting the rate of introduction of a laser-compatible material to displace laser-incompatible materials from the laser light path to obtain more favorable irradiation of the solid material. The method enable the conservation of the source of the laser-compatible material or improved irradiation of the solid material for solid removal by using the laser to cut, heat, fracture or melt the solid material.

### STATEMENT OF RELATED APPLICATIONS

This application claims priority to and depends from International PCT/US2013/023455 filed on 28 Jan. 2013, which claims priority to and depends from Hungarian application P1200062 filed on 26 Jan. 2012.

### BACKGROUND

1. Field of Invention

The present invention relates to the use of laser light to heat, cut, fracture or melt a material. More specifically, the present invention relates to a method of controlling an environment in a laser light path to enhance the effectiveness of the laser.

2. Background of the Related Art

Pipes, pipelines, tubing, casing and other types of structures having bores are used to transport gas, oil, chemicals, water, slurries and other materials. Various operations need to be performed within the bore for various purposes such as maintenance, cleaning, repair and modifications. As many bores are too small or otherwise unsuitable for human entry, many operations within a bore must be performed using remotely controlled devices.

Examples of such bores are found in earthen bores drilled to recover mineral deposits in the earth's crust. Bores are drilled into the earth's crust to establish fluid communication between a mineral deposit in the earth's crust and facilities on the surface. The earthen bore may require extension of a portion of the bore wall to access a different zone of a geologic formation or to more effectively drain an identified mineral deposit. The portion of the bore wall can be extended using conventional means, such as by using mechanical drill bits, using water jets or using a laser. A laser can extend a localized portion of the bore wall by impinging laser light on a targeted portion of a wall (hereinafter referred to as a targeted wall) and thereby fracturing or melting components of the formation into which the portion of the bore wall is being extended. The use of a laser to extend a portion of the bore wall may require that a laser head be positioned adjacent to the portion of the bore wall to be extended and remotely controlled.

Similarly, in an earthen bore that has been cased with a tubular called casing, a laser may be used to mill a window or a hole through the casing and/or a cement liner installed around the casing. As with extending a portion of the bore wall, the use of a laser to mill a window or hole in the casing and/or in the cement liner around the casing may require that a laser head be positioned adjacent to the portion of the targeted wall of the casing and/or cement liner to be removed, and the laser can be remotely controlled.

The use of a laser to cut, burn, melt or fracture a solid material, either for removal of a solid material from a targeted wall or for milling a window through a solid material at the targeted wall, may include the introduction of a laser-compatible material, such as insert gas, into the laser path intermediate the head connected to the end of an umbilical and the targeted wall. A laser-compatible material is a material through which laser light can pass to impinge on a targeted wall with effective transfer of energy to the targeted wall. Inert gas is a favorable laser-compatible material because it is generally non-reactive and stable, and because it does not impair the efficient transmission of laser light from the head to the targeted wall. The introduction of a laser-compatible material into the laser path may substantially enhance the effectiveness of the laser by displacing laser-incompatible materials from the laser light path. For example, but not by way of limitation, a laser-compatible material, such as an inert gas, may be introduced into a laser light path within an earthen bore to displace oil, water, brine, debris and other laser-incompatible materials that enter the bore from a geologic formation. The laser-incompatible materials will, unless displaced from the laser light path intermediate the head and the targeted wall, impair the efficient transmission of laser light from the head to the targeted wall and/or remove heat from the irradiated solid material at or on the targeted wall and thereby prevent effective cutting, burning, melting or fracturing of the targeted solid material.

A laser-compatible material, such as inert gas, can be delivered from a source to a gas port in the head through a gas conduit. The gas conduit can be provided within an umbilical along with a plurality of optical conduits that deliver laser light to the laser head. A leading end of the umbilical, to which the head is connected, is run into the bore and positioned, for example, using the umbilical, proximal to the targeted wall. Laser light is provided from a first end of the plurality of optical conduits to the head connected to the leading end of the umbilical for impingement on the targeted wall, and laser compatible fluid is provided from a first end of the gas conduit to the head for introduction into the laser path to displace laser-incompatible materials from the laser path to improve overall efficiency of the transfer of energy to the targeted wall.

### SUMMARY

In one aspect of the method of the present invention, an umbilical is run into a bore having a targeted wall. The targeted wall may have an unwanted solid adhered thereto, for example, but not by way of limitation, scale, hydrates, paraffin, or an unwanted biological growth. Alternately, the targeted wall itself may need to be removed in order to facilitate further operations such as sidetracking, the formation of a lateral bore, etc. In one aspect, a head is connected to a leading end of the umbilical and comprises one or more optical elements, a gas port and a light spectrum sensor. In an alternate aspect, the light spectrum sensor is omitted from the head and at least one conduit is provided for transmitting light resulting from irradiation of the targeted wall to the first end of the umbilical to a spectrum analyzer through an optical conduit. In the alternative aspect, the optical conduit through which the light resulting from irradiation of the targeted wall is transmitted to the spectrum analyzer may be one of the plurality of optical fibers that deliver laser light to the targeted wall.

In one aspect, the umbilical is used to position the head within the bore and includes a plurality of elongate optical conduits, such as, for example, optical fibers, optically connected at a first end to a laser light source and at a second, leading end to the one or more optical elements in the head. The umbilical further includes an elongate gas conduit fluidically connected at a first end to a source of laser-compatible gas, such as, for example, an insert gas, and connected at a second, leading end to the gas port on the head.

In one aspect, the umbilical includes a spectrum signal conduit connected at a first end to a spectrum analyzer and at a second, leading end to the spectrum sensor in the head. The sensor may generate a signal that is transmitted from the leading end of the spectrum signal conduit to the spectrum analyzer at the first end of the spectrum signal conduit. Alternately, as stated above, the sensor may be omitted from the head and raw light resulting from irradiation of the targeted wall can be transmitted through an optical conduit to a spectrum analyzer at the first end of the optical conduit. The optical conduit may either be a dedicated optical conduit, i.e. an optical conduit provided specifically for transmitting light resulting from irradiation of the targeted wall or, alternately, it may be an optical conduit through which laser light is delivered to the head for irradiation of the targeted wall, i.e., an optical conduit that serves a dual purpose of transmitting laser light from the first end to the leading end of the optical conduit while also transmitting light resulting from irradiation of the targeted wall from the leading end to the first end of the optical conduit.

In an alternate aspect, the spectrum signal conduit comprises an electrically conductive conduit that conducts a spectrum signal from the sensor in the head to the electronic signal analyzer at the first end of the electrically conductive conduit.

The head may comprise a mechanism to enable either the head or the optical elements in the head to be directed at an angle to the axis of the bore to impinge laser light emitted from the optical elements to irradiate a targeted wall. The laser light emitted from the optical elements of the head traverses a laser path intermediate the head and the targeted wall, and laser-compatible material, such as inert gas, is introduced through the gas port in the head to displace laser-incompatible materials from the laser path.

Laser light impinges on the targeted wall, such as a bore wall, to heat the targeted wall to cut, heat, fracture and/or melt at least some components of the targeted wall or some components of solids deposited on the targeted wall. Where the targeted wall bears unwanted solids, fracturing and/or melting of some components of the solid deposits will cause solid deposits to be removed from the targeted wall and will thereby restore or improve flow capacity of the bore. The optical elements in the head and the optical conduits in the umbilical should be selected to deliver the nature and character of laser light most suited for the intended application. For example, an optical element may provide more focused laser light for cutting through structural steel and/or cement, and another optical element may provide a broader, less focused laser light for heating, fracturing and/or melting unwanted solid deposits from the targeted wall.

In one aspect of the present invention, the sensor in the head is used to detect or sense a spectrum of light emitted by one or more components of materials that are irradiated using laser light emitted from the head and transmitted across the laser path to the targeted wall. The characteristics of the light spectrum resulting from irradiation of the targeted wall provide an indication of the temperature of the irradiated materials and, therefore, of the energy transfer rate from the head to the irradiated materials at or on the targeted wall resulting in the sensed light spectrum. In another, alternative aspect of the present invention, there is no sensor in the head, and the light generated by irradiation of solid material at or on the targeted wall is transmitted through an optical conduit to the first end of the optical conduit connected to a spectrum analyzer.

Access to data relating to the temperature of the irradiated materials at or on the targeted wall enables controlled adjustment of the rate at which laser compatible gas is provided into the laser path intermediate the head and the targeted wall. For example, but not by way of limitation, if the sensed light spectrum emitted by an irradiated material at or on the targeted wall indicates a material temperature that is below an optimal temperature range for effective cutting, heating, fracturing and/or melting of the material, the rate of introduction of the laser compatible gas may be increased to further displace laser-incompatible material from the laser light path and to thereby increase the rate of light transmission and the corresponding rate of heat transfer to the irradiated material. If the sensed light spectrum emitted by the irradiated material at or on the targeted wall increases to a predetermined optimal range as a result of the increase in the rate of introduction of the laser compatible gas to the laser path intermediate the head and the targeted wall, then more effective cutting, heating, fracturing or melting is achieved by the increase in the rate of introduction of the laser-compatible material.

Aspects of the method of the present invention may also be used to conserve laser compatible gas. For example, but not by way of limitation, if the sensed light spectrum emitted by an irradiated material on the targeted wall indicates a material temperature that is above an optimal temperature range for effective cutting, heating, fracturing or melting of the material, the rate of introduction of the laser-compatible material may be decreased at least to the flow rate at which the rate of introduction of laser-compatible material provides a detectable decrease in displacement of laser-incompatible materials from the laser light path. Upon detecting such a decrease, the rate of introduction of laser-compatible material may be increased only as much is needed to restore the detected light spectrum emitted by the irradiated material to the range that is optimal for the cutting, heating, fracturing or melting of the material on the targeted wall.

Optionally, an aspect of the method includes controlling the rate of introduction of laser-compatible material into the laser path intermediate the head and the targeted wall to be irradiated after obtaining a sample of the material, irradiating the sample using laser light, and sensing the nature and character of the light spectrum emitted by the irradiated material. This provides a series of light spectrum profiles or “signatures” that can be used to later correlate a sensed temperature to a known stage of laser performance. In another aspect of the method, the sensing of the nature and character of the light spectrum emitted by the irradiated material may include repeated sensing of the light spectrum over a range of concentrations of the laser-compatible material disposed intermediate the head and the targeted wall. Using these aspects, the overall effectiveness of the use of laser light to irradiate a material at or on a targeted wall can be improved by determining, prior to irradiation of the targeted wall, a light spectrum corresponding to favorable rate of irradiation of the material at or on the targeted wall that will result in effective cutting, heating, fracturing or melting of the material, and by monitoring, during irradiation of the material, the emitted light spectrum from the irradiated material and adjusting the rate of introduction of the laser-compatible material provided to the laser path to displace laser-incompatible materials from the laser light path and to obtain favorable irradiation of the targeted wall.

Aspects of the method of the present invention may be used to remove a variety of solid deposits that adhere to the wall of a bore including, but not limited to, solid deposits that adhere to the bore wall of pipes used to transport gas, oil, water, chemicals, or slurries. One such solid deposit includes scale, such as, for example, barium sulfate. Other such solid deposits include paraffin, hydrates, carbonates, and the like. Aspects of the method of the present invention may be used to improve the laser performance of lasers used to remove these solid deposits by heating and fracturing and/or melting the solid deposits.

Aspects of the method of the present invention may also be used to remove solid deposits including, but not limited to, solid deposits that adhere to the bore wall of casing or tubing in a well drilled to recover oil or gas or to facilitate the injection of brine, saltwater, water or other wastes. Solid deposits often result from the inability to reasonably control the pH, temperature or pressure within a pipe, pipeline, casing, tubing, tunnel, or other conduit through which materials are transported.

As stated above, the rate at which laser-compatible materials are introduced into the laser light path intermediate the head and the targeted wall is varied in response to the detection or sensing of a light spectrum indicating that an adjustment in the rate of introduction of the laser-compatible material is needed. A sensed light spectrum indicating insufficient heating and insufficient temperature may prompt an operator to increase the rate of introduction of the laser-compatible materials to displace laser-incompatible materials from the laser light path. A sensed light spectrum indicating either optimal or excessive heating and optimal or excessive temperature may prompt an operator to decrease the rate of introduction of the laser-compatible materials being introduced into the laser light path to conserve laser-compatible materials, i.e. inert gas.

Aspects of the method of the present invention use the impairment of laser transmission caused by laser-incompatible materials within the laser light path, and manifested through a sensed light spectrum indicating a sub-optimal temperature of the irradiated materials, to produce a detectable indicator of the efficiency of heat transfer to the targeted wall. Laser-compatible materials are used to displace laser-incompatible materials from the laser light path intermediate the head and the targeted wall and include inert gases such as, for example, nitrogen or argon. Other laser-compatible materials, such as noble gases, may be less favorable due to high cost of noble gases. The high heat capacity of some materials, such as water, and the resulting unwanted removal of heat from the irradiated materials at or on the targeted wall may make use of laser-transparent liquids unsuitable.

### BRIEF DESCRIPTION OF THE DRAWINGS

FIG. 1 is an example of a plurality of light spectrum profiles resulting from irradiation of solid materials in a known environment and illustrating an optimal range for effective heating of solid materials to cut, heat, fracture and % or melt the solid materials.

FIG. 2 is an illustration of a system comprising components used to implement an aspect of the method of the present invention.

FIG. 3 is a sectional view of a laser head connectable to a leading end of an umbilical used to implement an aspect of the method of the present invention.

FIG. 4 is a perspective view of a spool that can be used to store an umbilical as a component of a system used to implement an aspect of the method of the present invention.

FIG. 5 is a perspective view of an alternative spool that can be used to store an umbilical as a component of a system used to implement an aspect of the method of the present invention.

FIG. 6 is a perspective view of the laser head of FIG. 3.

FIG. 7 is a sectional view of an apparatus to orient the laser head of FIG. 3 to impinge laser light on a solid deposit adhered to a targeted wall.

FIG. 8 is an illustration of the laser head of FIGS. 3 and 6 oriented within a bore to impinge laser light through a laser path intermediate the head and a targeted wall to irradiate solids deposited thereon. Solid deposit heating is impaired in FIG. 8 by laser-incompatible materials obstructing the laser light path.

FIG. 9 is an example of a profile of a light spectrum resulting from irradiation of solid deposits in FIG. 8.

FIG. 10 is the illustration of FIG. 8 after solid deposit heating is improved by displacement of laser-incompatible materials from the laser light path by increasing the rate of introduction of a laser-compatible material.

FIG. 11 is an example of a profile of a light spectrum resulting from irradiation and removal of solid deposits in FIG. 10.

### DETAILED DESCRIPTION

One aspect of the method of the present invention comprises running an umbilical, having a head connected to a leading end of the umbilical, into a bore with a wall having a solid material to be irradiated at or on the wall. In one aspect, the head has one or more optical elements, a gas port and a light spectrum sensor. Other aspects omit the light spectrum sensor, as will be discussed herein. Provided in the umbilical is a plurality of optical conduits connected at a first end of the umbilical to a laser light source, such as a laser light generator, and connected at a leading end of the umbilical to the one or more optical elements in the head. Provided in the umbilical is a gas conduit connected at a first end to a pressurized gas source, such as a gas tank, gas bottle or a gas compressor, and at a leading end to the gas port in the head. Also provided in the umbilical, in one aspect, is a sensor signal conduit, such as an optical conduit or an electrically conductive conduit, connected at a first end to a signal receiver and connected to a leading end to a light spectrum sensor in the head. The head is positioned within a bore having a wall using the umbilical or using some remotely-controllable steering or positioning system. Laser light is transmitted from the laser light source through the plurality of optical conduits and the optical elements in the head to irradiate a solid material at or on a targeted wall proximal to the head. A laser-compatible material, such as an inert gas or a noble gas, is introduced from the gas source through the gas conduit and into the laser light path intermediate the head and the targeted wall to displace at least some laser-incompatible materials from the laser light path and to thereby promote the efficient transfer of energy from the head, across the laser light path to the irradiated material on or at the targeted wall.

Light produced as a result of laser-irradiation of the targeted wall has a detectable frequency or wavelength that indicates the temperature of the irradiated solid material. In aspects having a sensor in the head, the sensor senses a light spectrum, which is like a “signature” indicating the effectiveness of the laser-irradiation of solids at or on the targeted wall. A signal is generated by the sensor and transmitted from the sensor through the sensor signal conduit to the signal receiver connected to the first end of the sensor signal conduit. The signal is received and may be compared with light spectrums produced by irradiating the solid material at or on the targeted wall, or suspected to be at or on the targeted wall, at known temperatures. The sensing of the light spectrum generated by irradiation of the targeted wall, and the optional correlation of the light spectrum resulting from previous irradiations of the solid material at or on the targeted wall, enables an assessment of the general efficiency of energy transfer from the head, across the laser light path to the solid material at or on the targeted wall. An unfavorable efficiency can be remediated by increasing the rate of introduction of laser-compatible material, such as insert gas, into the laser light path to displace laser-incompatible materials and to improve transmission of laser light from the head to the irradiated solid material. A favorable efficiency can be maintained, or the rate of introduction of laser-compatible material into the laser light path can be decreased to conserve the source of the laser-compatible material, with caution taken to reassess the efficiency of the energy transfer after reduction of the rate of introduction of the laser-compatible material.

In another aspect of the method, a second light spectrum resulting from irradiation of the solid material at or on the targeted wall is sensed after adjustment of the rate at which the laser-compatible material is introduced through the gas conduit. Further adjustments may be made to move the light spectrum sensed to a favorable range.

In one aspect, the method includes introducing a laser-compatible gas comprising nitrogen or argon, another inert gas or a noble gas. The gas is introduced into the laser light path through a gas port in the head that directs the stream of gas exiting the gas port toward the laser light path to displace laser-incompatible materials from the laser light path.

In one aspect of the method of the present invention, the head is movably connected to the leading end of the umbilical at an articulating joint intermediate the head and a leading end of the umbilical. The articulating joint may be controlled to orient the head at an angle to the axis of the bore in which the head is disposed to impinge laser light on a targeted wall of the bore. In one aspect, the articulating joint is controlled using an electrically conductive conduit and an electric motor within the umbilical, the articulating joint or the head to move the articulating joint between a straight configuration, in which the head is moved and positioned within the bore, and an angled configuration, in which laser light provided through the optical conduits is emitted from the head. In one aspect, the articulating joint is actuated from a straight configuration to the angled configuration by providing gas pressure to the gas conduit. It will be understood that a gas cylinder can be provided in or adjacent to the articulating joint, along with a spring element to bias the articulating joint to the straightened configuration. The gas cylinder can be actuated by providing pressurized gas to the gas port to overcome the spring element and to move the articulating joint to the angled configuration. In this aspect, the provision of gas pressure to the gas conduit serves a dual purpose; that is, to actuate the articulating joint to orient the head and to introduce a laser compatible material (gas) through the gas port to the laser light path.

In one aspect, gas pressure is provided to the gas conduit to operate one or more gas cylinders to deploy a centralizer fitted onto the or near the leading end of the umbilical. In this aspect, the provision of gas pressure to the gas conduit serves a dual purpose; that is, to deploy the centralizer to generally center the head in the bore and to introduce a laser compatible gas into the laser light path to increase the efficiency of energy transfer from the head to the solid material at or on the targeted wall.

In another aspect of the method of the present invention, the provision of gas pressure to the gas conduit serves a triple purpose of actuating the articulating joint, actuating additional gas cylinders to deploy one or more centralizers on the head or on the umbilical proximal to the head and providing a laser-compatible material to the laser light path.

Another aspect of the method of the present invention comprises providing within the umbilical an electrically conductive conduit, and then transmitting electrical current through the electrically conductive conduit to operate a valve or a motor in the head to deploy a gas cylinder coupled to a centralizer fitted onto or near the leading end of the umbilical or fitted onto the head. Another aspect of the method of the present invention comprises providing within the umbilical an electrically conductive conduit, and transmitting electrical signals from the light spectrum sensor in the head and at the leading end of the electrically conductive conduit to an electronic signal receiver at a first end of the electrically conductive conduit. The electrical signals may relate to the sensed light spectrum or to the position of a valve coupled to a fluid cylinder.

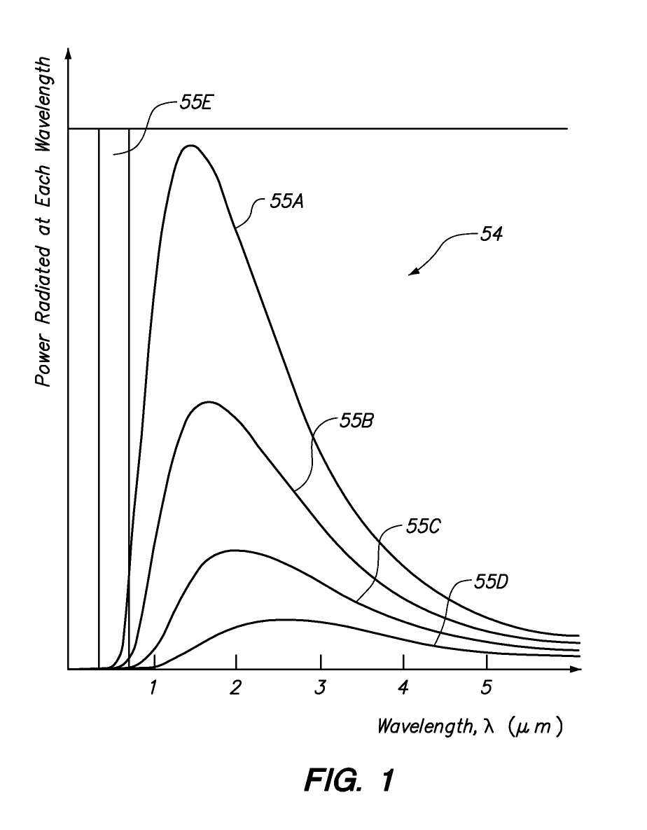

FIG. 1 is a graph 54 bearing a plurality of sensed light spectrum profiles resulting from irradiation of a solid material in a generally known and controlled environment. Band 55E is an illustration of the visible light spectrum, roughly corresponding to 400 to 700 nm. The profiles 55A-55D correspond to varying sensed light spectrums resulting from the irradiation of the solid material in varying known and controlled environments. For example, but not by way of limitation, a first profile 55A on FIG. 1 may correspond to irradiation of the solid material in a “clean,” or favorably displaced, environment having little or no laser-incompatible materials in the laser light path to disrupt or otherwise block efficient transfer of energy from the head to the irradiated material. The second, third and fourth profiles, 55B, 55C and 55D illustrate light profiles that may be obtained by irradiating the solid material using laser light of the same intensity but in environments having an increasing concentrations or densities of laser-incompatible materials present in the laser light path. It will be understood that an operator may, in response to sensing the light profiles 55B, 55C or 55D, increase the rate at which laser-compatible material is introduced into the laser light path intermediate the head to displace laser-incompatible materials to obtain a light profile at or close to that illustrated by light profile 55A, which illustrates an optimal light profile indicating effective heating of the irradiated solid material, which can be unwanted solid deposits adhered to the bore wall or the interior wall of a steel casing or tubing to be cut using the laser head. After adjustment of the rate of introduction of the laser compatible gas, the concentration or density of laser-incompatible materials in the laser light path will be moved to or towards the optimal range, and the irradiated solid materials will be more effectively cut, heated, fractured and/or melted by the impingement of laser light emitted from the one or more optical elements in the head. It will be understood that obtaining and irradiating samples of the solid material to be irradiated to obtain the light profiles 55A-55D illustrated in FIG. 1 is optional, and that these steps are not essential to implementation of methods of the present invention.

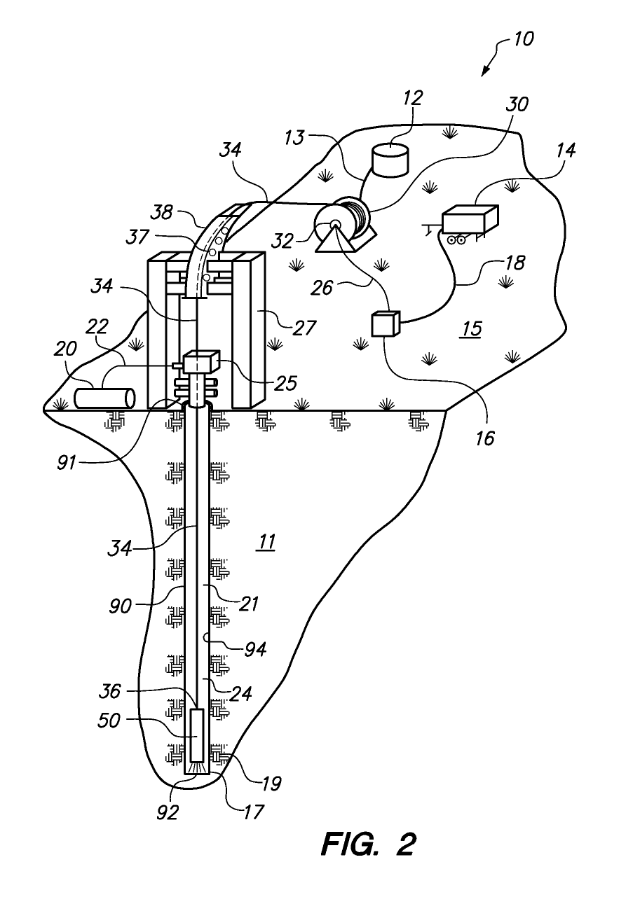

FIG. 2 is a schematic illustrating components and systems 10 that may be used to implement an aspect of the method of the present invention. A bore 90 is drilled into the earth's crust 11 so that a portion 17 of the bore 90 penetrates a geologic formation 19 bearing a fluid medium such as, for example, hydrocarbons. The system 10 comprises a coiled tubing unit at the surface 15 having a source of pressurized gas 12 fluidically coupled through a gas leader 13 to a gas conduit (not shown) within an umbilical 34, a portable electric generator 14 electrically coupled through a power supply leader 18 to power a laser light generator 16 that is, in turn, optically coupled through a laser leader 26 to a plurality of optical fibers 47 (not shown in FIG. 2) within the umbilical 34. The components and systems 10 of FIG. 2 further comprise a wellhead 25 sealing the surface end 91 of the bore 90 through which the umbilical 34 is received into the bore 90, a working fluid tank 20 coupled through a working fluid leader 22 to the wellhead 25 to enable the introduction and removal of working fluid 21 into and from an annulus 24 between the umbilical 34 and the wall 94 of the bore 90. The components and systems 10 further comprise a spool 30 on which an extended length of umbilical 34 may be stored, and a coiled tubing unit guide support 27 to support an umbilical guide 38 having a plurality of rolling elements 37 therein to reduce friction of movement of the umbilical 34 into and from the wellhead 25 and the bore 90. The components and systems 10 and the coiled tubing unit thereof further comprise a head 50 connected at a connected end 36 to the umbilical 34 and positionable within the bore 90 by letting out and reeling in the umbilical 34 from and onto the spool 30.

The components and systems 10 comprise the spool 30 that is rotatable on an axle (not shown in FIG. 2) using a motor and related gears (not shown) to control the position of the head 50 by letting out and reeling in the umbilical 34 thereon. In FIG. 2, the spool 30 has been reeled out to provide sufficient umbilical 34 through the wellhead 25 to position the head 50 adjacent to a portion of the wall to be conditioned 92, which is a small portion of the wall 94 of the bore 90 that is adjacent the head 50.

The components and systems 10 illustrated in FIG. 2 can also be adapted for and used in a pipeline, a pipe, or a bore of some other type, other than an earthen bore, in which the laser irradiation of a solid material at or on a targeted wall can be used to cut, heat, fracture and/or melt the solid in the presence of an introduced laser-compatible material. For illustration, the bore 90 of FIG. 2 can simply be re-oriented in FIG. 2 to represent a horizontal flowline, pipe or pipeline or some other type of bore, and the same components and systems 10 can be used to implement aspects of the method of the present invention in a horizontal or inclined bore, as opposed to the purely vertical bore 90 illustrated in FIG. 2.

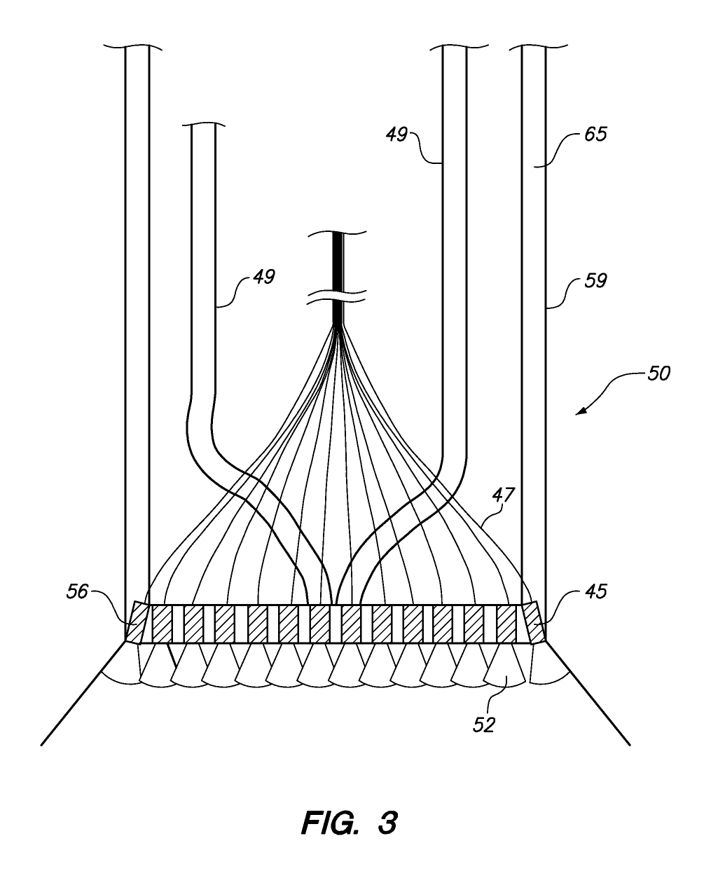

FIG. 3 is an enlarged sectional view of the head 50 of FIG. 2 connectable to a leading end of an umbilical 34 (not shown in FIG. 3) to implement an aspect of the method of the present invention. The head 50 of FIG. 3 can be positioned within a bore 90 (see FIG. 2) to irradiate a solid material in accordance with the method of the present invention. The head 50 of FIG. 3 comprises a case 65 having an exterior surface 59, a plurality of optical fibers 47 within the case 65 and optically coupled to optical elements 45 housed in a generally concentric pattern at a leading end 56 of the head 50 to irradiate the wall portion 92 (see FIG. 2) with laser light 52 upon activation. The head 50 of FIG. 3 further comprises laser-compatible material conduits 49 to provide laser-compatible material to gas ports 46 (not shown in FIG. 3—see FIG. 6) for introducing laser-compatible materials and for displacing laser-incompatible materials from a laser path 52 proximal the leading end 56 of the head 50.

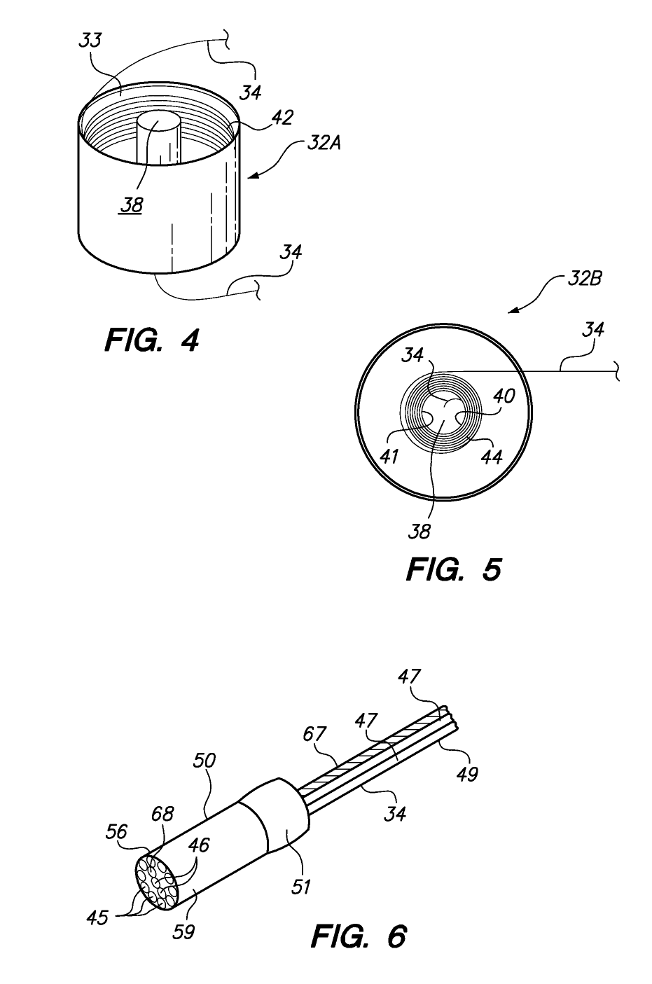

FIG. 4 is a perspective view of an alternative umbilical storage spool 32A that can be used to store an umbilical 34 of a system of the present invention by coiling the umbilical 34 against the interior wall 33 of the spool 32A. After a portion of the interior wall 33 is covered with outer coils 42 of the umbilical 34, additional, smaller coils can be disposed within the initial, outer coils 42 for additional storage capacity. FIG. 5 is a top view of a second alternative umbilical spool 32B that can be used to store an umbilical 34 of a system of the present invention by wrapping coils 44 around an exterior wall 41 of a center post 38 of the spool 34B. After a portion of the exterior wall 41 is covered with coils 44 of the umbilical 34, additional, larger coils can be disposed about the initial, inner coil 40 for additional storage capacity.

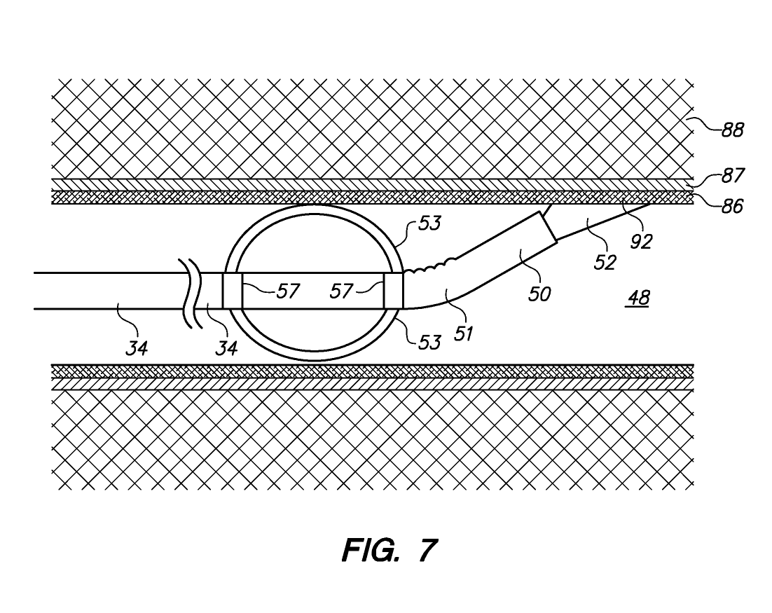

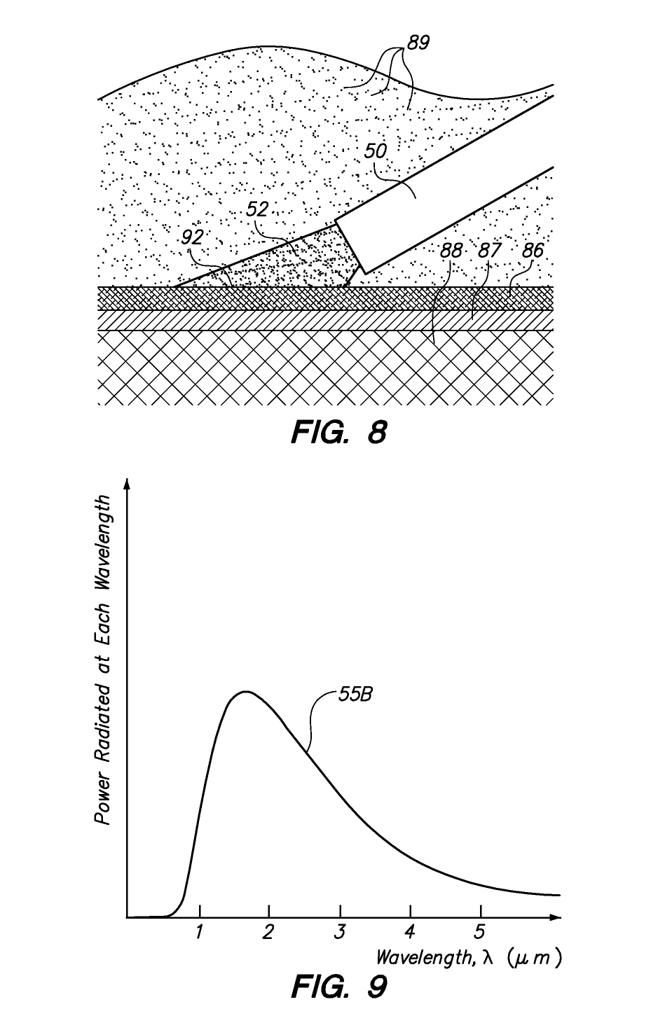

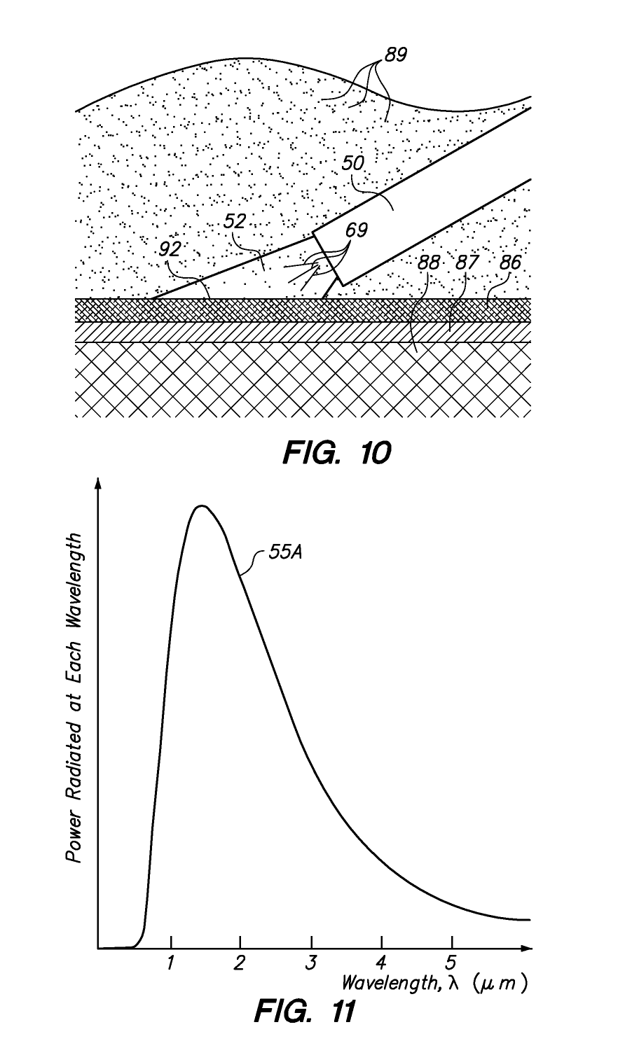

FIG. 6 is a perspective view of the head 50 of FIG. 3. FIG. 6 illustrates an articulating joint 51 disposed intermediate the head 50 and the umbilical 34. FIG. 6 reveals the optical elements 45 in a generally concentric pattern about the gas ports 46. Laser-compatible material (not visible in FIG. 6) is provided through the gas conduit 49 to the gas ports 46 that are directed towards the laser light path (not shown in FIG. 6—see FIGS. 8 and 10). Laser light is provided through the optical conduits 47 to the optical elements 45 that are also directed at the targeted wall (not shown in FIG. 6). Auxiliary conduit 67 may, in one aspect, be a spectrum signal conduit, either optical or electrically conductive, or it may comprise an electrically conductive conduit to operate an electric motor to actuate the articulating joint 51 or a deployable centralizer (not shown in FIG. 6—see FIG. 7). In one aspect of the method of the present invention, the auxiliary conduit 67 is a spectrum signal conduit connected at a leading end to light spectrum sensor 68 in the head 50. Light spectrum sensor 68 senses the intensity and/or wavelength of light resulting from irradiation of a targeted wall 92 (not shown in FIG. 6—see FIG. 2) and generates a signal (not shown) to a signal analyzer at the first end (not shown) of the spectrum signal conduit 67. In an alternative aspect of the method of the present invention wherein a sensor is not provided in the head 50, element number 68 in FIG. 6 may indicate the end of auxiliary conduit 67, which may be an optical conduit, to receive and transmit light resulting from irradiation of solid materials at or on the targeted wall to a spectrum analyzer (not shown) connected to the first end of the auxiliary conduit 67.

FIG. 7 is a partial sectional view of a head 50 having an articulating joint 51 that is actuatable to orient the head 50 of FIGS. 3 and 6 to impinge laser light 52 on a solid material 86 adhered to a targeted wall 92 which, in the illustration of FIG. 7, is a portion of pipe wall 87. FIG. 7 illustrates a bore 48 in a medium 88 that is lined with a pipe 87 to which is adhered a layer of unwanted solid deposits 86. In FIG. 7, a centralizer having bow springs 53 connected to movable collars 57 is fitted onto the umbilical 34. Gas cylinders (not shown) may be connected to collars 57 to provide a centralizer that deploys upon provision of gas pressure through the gas conduit 49 (not shown in FIG. 7—see FIG. 6).

FIG. 8 is an illustration of the head 50 of FIGS. 3 and 6 oriented to impinge laser light 52 through a laser light 52 path intermediate the head 50 and a targeted wall 92 to irradiate solids 86 deposited on the targeted wall 92. In FIG. 8, effective heating of the solids 86 deposited on the targeted wall 92 is impaired by laser-incompatible materials 89 present in the laser light 52 path.

FIG. 9 is an example of a profile 55B of a light spectrum resulting from irradiation of targeted wall 92 in FIG. 8. It will be noted, by comparing FIG. 8 to the plurality of profiles 55A, 55B, 55C and 55D in FIG. 1, that the profile 55B of the light spectrum sensed by the sensor 68 (not shown in FIG. 9—see FIG. 6) is substantially below the profile 55A indicating an efficient transfer of energy from the head 50 to the targeted wall 92 (not shown in FIG. 9—see FIG. 2). It will be understood that, on other aspects of the method of the present invention, there is no sensor in the head 50 of FIG. 6, and the element number 68 in FIG. 6 corresponds to the leading end of an optical conduit 67 that transmits light resulting from the irradiation of the targeted wall to the first end of the optical conduit 67 to a spectrum analyzer. The cause of the poor energy transfer indicated by profile 55B in FIG. 9 is the high concentration or density of laser-incompatible material 89 in the laser light 52 path in FIG. 8.

FIG. 10 is the illustration of FIG. 8 after solid material on the targeted wall 92 is improved by displacement of laser-incompatible materials 89 from the laser light 52 path by increasing the rate of introduction of a laser compatible gas 69. It will be understood that the substantially lower concentration or density of laser-incompatible materials 89 in the laser light 52 path in FIG. 10 will result in improved energy transfer from the head 50 to the targeted wall 92.

FIG. 11 is an example of a substantially improved profile 55A of a light spectrum resulting from irradiation of solid materials 86 on the targeted wall 92 in FIG. 10. It will be understood by comparing the sensed profile 55A to FIG. 1 that the overall energy transfer efficiency in the cutting, heating, fracturing and/or melting of solid material 86 in FIG. 8 is substantially improved, as illustrated in FIG. 10, by the introduction of laser-compatible material 69 into the laser light path 52 to improve the overall energy transfer rate.

It will be understood that the illustrations in FIGS. 8 and 10 of the use of a head 50 to irradiate a targeted wall 92 to which an unwanted solid deposit 86 is adhered is not limiting of the applications of aspects of the method of the present invention, and that the head 50 could also be used to cut or to burn a window or a hole in the pipe wall 87 in FIGS. 8 and 10, and that the use of a light spectrum resulting from such operations is also usable in that operation to determine the general efficiency of energy transfer from the head 50 to the targeted wall 92. It will be understood that the term “targeted wall,” as used herein, may be used to refer to a pipe wall or to a solid deposit adhered to a pipe wall, and that the aspects of the method of the present invention are not limited to the mere removal of unwanted solid deposits from a wall but also to the removal of a portion of the wall.

As used herein, the singular forms “a”, “an” and “the” are intended to include the plural forms as well, unless the context clearly indicates otherwise. The terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The aspect was chosen and described in order to best explain the principles of the invention and the practical application, and to enable others of ordinary skill in the art to understand the invention for various aspects with various modifications as are suited to the particular use contemplated.

We claim:

1. A method, comprising:
running an umbilical having a head connected to a leading end of the umbilical into a bore with a wall, the head having one or more optical elements, a gas port and a light spectrum sensor;
providing in the umbilical a plurality of optical conduits connected at a first end of the umbilical to a laser light source and connected at a leading end of the umbilical to the one or more optical elements in the head;
providing in the umbilical a gas conduit connected at a first end to a pressurized gas source and at a leading end to the gas port in the head;
providing in the umbilical a sensor signal conduit connected at a first end to a signal receiver and at a leading end to the light spectrum sensor in the head;
transmitting laser light through the plurality of optical conduits to irradiate a targeted portion of the wall proximal to the head;
introducing a laser-compatible material through the gas conduit to displace laser-incompatible materials from a laser light path intermediate the head and the targeted portion of the wall;
sensing with the sensor a light spectrum resulting from irradiation of the solid material at the targeted portion of the wall; and
adjusting the rate at which the laser-compatible material is introduced into the leading end of the gas conduit in response to sensing the light spectrum resulting from irradiation of the solid material.

2. The method of claim 1, further comprising:
sensing with the sensor a second light spectrum resulting from irradiation of the solid at the targeted portion of the wall.

3. The method of claim 1, further comprising:
comparing the sensed light spectrum with one or more known light spectrums corresponding to irradiation of the solid material at the targeted portion of the wall;
correlating the sensed light spectrum to a known light spectrum producing an unfavorable irradiation of the solid material at the targeted portion of the wall; and
wherein adjusting the rate at which the laser-compatible material is introduced into the leading end of the gas conduit comprises:
increasing the rate at which laser-compatible material is introduced into the leading end of the gas conduit to displace laser-incompatible materials from the laser light path intermediate the head and the targeted portion of the wall.

4. The method of claim 1, further comprising:
comparing the sensed light spectrum with one or more known light spectrums corresponding to irradiation of the solid material at the targeted portion of the wall;
correlating the sensed light spectrum to a known light spectrum producing a favorable irradiation of the solid material at the targeted portion of the wall; and
wherein adjusting the rate at which the laser-compatible material is introduced into the leading end of the gas conduit comprises:
decreasing the rate at which laser-compatible material is introduced into the leading end of the gas conduit to conserve the source of laser-compatible material.

5. The method of claim 1, wherein the laser compatible material is one of nitrogen gas and argon gas.

6. The method of claim 1, further comprising:
providing an articulating joint intermediate the head and a leading end of the umbilical;
actuating the articulating joint to orient the head to impinge laser light emitted through the one or more optical elements is directed at the targeted portion of the wall.

7. The method of claim 6, further comprising:
providing within the umbilical an electrically conductive conduit; and
transmitting an electrical current to a valve in the head to operate a motor to actuate the articulating joint.

8. The method of claim 6, further comprising:
providing within the umbilical an electrically conductive conduit; and
transmitting an electrical current to a valve in the head to deploy a centralizer.

9. The method of claim 1, further comprising:
providing within the umbilical an electrically conductive conduit; and
transmitting electrical signals from the light spectrum sensor at the leading end of the electrically conductive conduit to an electronic signal receiver at a first end of the electrically conductive conduit.

10. The method of claim 1, wherein the bore is within a pipeline.

11. The method of claim 1, wherein the bore is within an earthen bore.

12. A method, comprising:
running an umbilical having a head connected to a leading end of the umbilical into a bore with a wall, the head having one or more optical elements and a gas port;
providing in the umbilical a plurality of optical conduits connected at a first end of the umbilical to a laser light source and connected at a leading end of the umbilical to the one or more optical elements in the head;
providing in the umbilical a gas conduit connected at a first end to a pressurized gas source and at a leading end to the gas port in the head;
providing in the umbilical a monitoring optical conduit connected at a first end to a spectrum analyzer;
disposing a leading end of the monitoring optical conduit proximal to a targeted portion of a wall proximal to the head;
transmitting laser light through the plurality of optical conduits to irradiate a solid material at the targeted portion of the wall proximal to the head;
introducing a laser compatible material through the gas conduit to displace laser-incompatible materials from a laser light path intermediate the head and the irradiated wall;
transmitting light resulting from irradiation of the solid material at the targeted portion of the wall through the monitoring optical conduit to the spectrum analyzer; and
adjusting the rate at which the laser compatible gas is introduced into the leading end of the gas conduit in response to the spectrum of the light transmitted to the spectrum analyzer.

13. The method of claim 12, further comprising:
comparing the light resulting from irradiation of the solid material with one or more known light spectrums corresponding to irradiation of the solid material at the targeted portion of the wall; and
wherein adjusting the rate at which laser compatible gas is introduced into the leading end of the gas conduit comprises:
increasing the rate at which laser-compatible material is introduced into the leading end of the gas conduit to displace laser-incompatible materials from the laser light path intermediate the head and the targeted portion of the wall.

14. The method of claim 12, further comprising:
transmitting a light spectrum resulting from irradiation of the solid material at the targeted portion of the wall after adjustment of the rate at which the laser-compatible material is introduced into the leading end of the gas conduit to the spectrum analyzer through the light spectrum conduit.

15. The method of claim 12, wherein comparing the light spectrum resulting from irradiation of the solid material with one or more light spectrums corresponding to irradiation of the solid material at the targeted portion of the wall comprises:
correlating the transmitted light spectrum to an unfavorable light spectrum for removal of the solid material from the targeted portion of the wall; and
wherein adjusting the rate at which the laser-compatible material is introduced through the gas conduit comprises:
increasing the rate of introduction of the laser-compatible material to increase displacement of laser-incompatible materials from the laser light path intermediate the head and the targeted portion of the bore wall.

16. The method of claim 1, wherein comparing the light spectrum resulting from irradiation of the solid material with one or more light spectrums corresponding to irradiation of the solid material at the targeted portion of the wall comprises:
correlating the transmitted light spectrum to a light spectrum corresponding to an unfavorable irradiation of the solid material at the targeted portion of the wall; and
wherein adjusting the rate at which the laser-compatible gas is introduced through the gas conduit comprises:
decreasing the rate of introduction of laser-compatible material to conserve the pressurized gas source of the laser-compatible material.

17. The method of claim 12, wherein the laser-compatible material is nitrogen gas.

18. The method of claim 12, wherein the laser-compatible material is argon gas.

19. The method of claim 12, further comprising:
providing an articulating joint intermediate the head and a leading end of the umbilical;
actuating the articulating joint to orient the head; and
impinging laser light emitted through the one or more optical elements on the solid material at the targeted portion of the wall.
